(19) United States
(12) Patent Application Publication
(10) Pub. No.: US 2009/0129246 A1
(43) Pub. Date: May 21, 2009

(54) ENVIRONMENTAL MANAGEMENT OF A PROBE STORAGE DEVICE

(75) Inventor: Peter David Ascanio, Fremont, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/269,810

(22) Filed: Nov. 12, 2008

Related U.S. Application Data
(60) Provisional application No. 60/989,715, filed on Nov. 21, 2007.

(51) Int. Cl. G11B 9/00

(52) U.S. Cl. 369/126; G9B/9

(57) ABSTRACT

A system for storing information comprises a package including a lid, a bowl mateable with the lid, and leads extending from an interior of the package to an exterior of the package. A magnet structure includes a first flux plate and a magnet and is fixedly connected with the lid by way of the first flux plate. A media stack includes a cap including cut-outs for receiving at least a portion of the magnet structure, a media frame connected to the cap, a tip die connected to the media frame, and a second flux plate connected with the tip die. A movable media platform is movably connected with the frame and arranged between the cap and the tip die. An electric trace is formed on the media platform so that the electric trace is arranged between the media platform and the cap. A media is fixedly associated with the movable media platform and accessible to the tip die. The media stack is seated within the bowl and wire-bonded to the leads.

### CLAIM OF PRIORITY

This application claims benefit to the following U.S. Provisional Patent Application:

U.S. Provisional Patent Application No. 60/989,715 entitled “ENVIRONMENTAL MANAGEMENT OF A PROBE STORAGE DEVICE,” by Peter David Ascanio, filed Nov. 21, 2007, Attorney Docket No. NANO-01081US0.

### TECHNICAL FIELD

This invention relates to systems for storing information.

### BACKGROUND

Software developers continue to develop steadily more data intensive products, such as ever-more sophisticated, and graphic intensive applications and operating systems (OS). Higher capacity data storage, both volatile and non-volatile, has been in persistent demand for storing code for such applications. Add to this need for capacity, the confluence of personal computing and consumer electronics in the form of personal MP3 players, such as iPod®, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to digital video recorders use hard disk drives. While hard disk drives store large amounts of data, they consume a great deal of power, require long access times, and require “spin-up” time on power-up. FLASH memory is a more readily accessible form of data storage and a solid-state solution to the lag time and high power consumption problems inherent in hard disk drives. Like hard disk drives, FLASH memory can store data in a non-volatile fashion, but the cost per megabyte is dramatically higher than the cost per megabyte of an equivalent amount of space on a hard disk drive, and is therefore sparingly used. Consequently, there is a need for solutions which permit higher density data storage at a reasonable cost per megabyte.

### BRIEF DESCRIPTION OF THE DRAWINGS

Further details of the present invention are explained with the help of the attached drawings in which:

FIG. 1 is an exploded perspective view of a memory device comprising a movable media platform accessible to a plurality of tips extendable from a tip die.

FIG. 2 is a simplified cross-sectional view of the memory device of FIG. 1 arranged within a package.

FIG. 3 is an exploded perspective view of an alternative embodiment of a memory device in accordance with the present invention wherein support structures extend from the tip die to a cap to resist deformation forces applied to the memory device.

FIG. 4 is an exploded perspective view of a further embodiment of a memory device in accordance with the present invention wherein thickness of the cap is increased.

FIG. 5A is a contour map produced using finite element modeling illustrating distortion of a media cavity of the memory device of FIG. 1 subjected to high external pressure.

FIG. 5B is a contour map produced using finite element modeling illustrating distortion of a media cavity of a memory device having a single, centrally arranged compression member subjected to high external pressure.

FIG. 5C is a contour map produced using finite element modeling illustrating distortion of a media cavity of the memory device of FIG. 3 subjected to high external pressure.

FIG. 5D is a contour map produced using finite element modeling illustrating distortion of a media cavity of the memory device of FIG. 4 subjected to high external pressure.

FIG. 5E is a contour map produced using finite element modeling illustrating distortion of a media cavity of a memory device having nine posts and increased cap thickness subjected to high external pressure.

FIG. 6A is a contour map produced using finite element modeling illustrating distortion of a media cavity of the memory device of FIG. 1 subjected to high internal pressure.

FIG. 6B is a contour map produced using finite element modeling illustrating distortion of a media cavity of a memory device having a single, centrally arranged compression member subjected to high internal pressure.

FIG. 6C is a contour map produced using finite element modeling illustrating distortion of a media cavity of the memory device of FIG. 3 subjected to high internal pressure.

FIG. 6D is a contour map produced using finite element modeling illustrating distortion of a media cavity of the memory device of FIG. 4 subjected to high internal pressure.

FIG. 6E is a contour map produced using finite element modeling illustrating distortion of a media cavity of a memory device having nine posts and increased cap thickness subjected to high internal pressure.

FIG. 7A is an exploded perspective view of an embodiment of a memory device and package in accordance with the present invention.

FIG. 7B is a partially exploded perspective view of the memory device and package of FIG. 7A, wherein a media stack of the memory device is seated within the package.

FIG. 7C is a perspective view of the memory device and package of FIG. 7A, wherein a lid is fixedly connected to a bowl to seal the memory device within the package.

FIG. 7D is a cross-sectional view of the memory device and package of FIG. 7A.

FIG. 7E is a cross-sectional view of the memory device and package of FIG. 7A subjected to a shock or torque.

### DETAILED DESCRIPTION

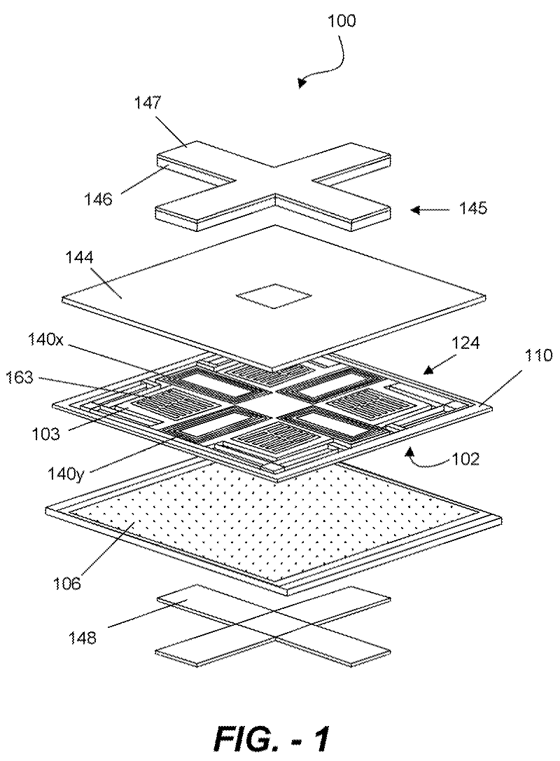

FIG. 1 is an exploded perspective view of a system for storing information 100 (also referred to herein as a memory device) comprising a tip die 106 from which extends a plurality of tips contactable with a media 102 of a media die 124 for forming, removing and/or reading indicia in the media 102 and/or on the surface of the media 102. One or both of the tip die 106 and the media 102 can be movable to allow the plurality of tips to access the recordable surface of the media 102. As shown in FIG. 1, the tip die 106 is bonded to the media die 124 and the media 102 is moved relative to the plurality of tips.

The media 102 for storing indicia is associated with a movable media platform 103 of the media die 124. The movable media platform 103 is suspended and movable within a media frame 110 of the media die 124 and is electrically connected with a memory device controller to form a circuit to communicate signals from a tip to the media 102 when a tip is in electrical communication with the media 102. The movable media platform 103 is movable in a Cartesian plane relative to the media frame 110 by way of electromagnetic motors comprising operatively connected electrical traces 140 (also referred to herein as coils, although the electrical traces need not consist of closed loops) placed in a magnetic field so that controlled movement of the movable media platform 103 can be achieved when current is applied to the electrical traces 140. The movable media platform 103 is urged in a Cartesian plane by taking advantage of Lorentz forces generated from current flowing in the coils 140 when a magnetic field perpendicular to the Cartesian plane is applied across the coil current path. The coils 140 can be arranged at ends of two perpendicular axes and can be formed such that the media 102 is disposed between the coils 140 and the tip die 106 (e.g. fixedly connected or integrally formed with a back of the movable media platform 103, wherein the back is a surface of the movable media platform 103 opposite a surface contactable by tips extending from the tip die 106). In a preferred embodiment, the coils 140 can be arranged symmetrically about a center of the movable media platform 103, with one pair of coils 140x generating force for lateral (X) motion and the other pair of coils 140y generating force for transverse (Y) motion. Utilization of the tip-accessible surface of the movable media platform 103 for data storage need not be affected by the coil layout because the coils 140 can be positioned so that the media 102 for storing indicia is disposed between the coils 140 and the tip die 106, rather than co-planar with the coils 140. In other embodiments the coils can be formed co-planar with the surface of movable media platform. In such embodiments, a portion of the tip-accessible surface of the movable media platform will be dedicated to the coils, reducing utilization for information storage.

A magnetic field is generated outside of the movable media platform 103 by a permanent magnet 146 arranged so that the permanent magnet 146 approximately maps the two perpendicular axes, the ends of which include the coils 140. The permanent magnet 146 can be fixedly connected with a rigid structure such as a flux plate 147 to form a magnet structure 145. The flux plate 147 can be formed from steel, or some other material for containing magnet flux. The magnet structure can be fixedly associated with a cap 144 that can be bonded to the media frame 110 to seal the movable media platform 103 between the tip die 106 and the cap 144. A second flux plate 148 can be arranged so that the tip die 106, movable media platform 103, and coils 140 are disposed between the magnet structure 145 and the second flux plate 148. The magnetic flux is contained within the gap between the magnet structure 145 and the second flux plate 148. As above, the second flux plate 148 can be formed from steel, or some other material for containing magnet flux. In alternative embodiments, a pair of magnet structures can be employed such that the movable media platform 103, tip die 106 and coils 140 are disposed between dual magnets, thereby increasing the flux density in the gap between the magnets. The force generated from the coil 140 is proportional to the flux density, thus the required current and power to move the movable media platform 103 can be reduced at the expense of a larger package thickness. There is a possibility that a write current applied to one or more tips could disturb the movable media platform 103 due to undesirable Lorentz force. However, where the media 102 comprises phase change material, polarity dependent material, ferroelectric material or other material requiring similar or smaller write currents to induce changes in material properties, movable media platform movement due to write currents is sufficiently small as to be within track following tolerance. In some embodiments, it can be desired that electrical trace lay-out be configured to generally negate the current applied to the tip, thereby minifying the influence of write current.

Coarse servo control of the movable media platform 103 as it moves relative to one or more other components of the memory device 100 can be achieved through the use of sensors fabricated on the movable media platform 103 and the one or more components. The sensors can include, for example, Hall-effect sensors sensitive to magnetic field, thermal sensors, and capacitive sensors. Referring to the memory device 100 of FIG. 1, capacitive sensors can be fabricated on the movable media platform 103 and the cap 144, for example as described in U.S. patent application Ser. No. 11/553,421, entitled “BONDED CHIP ASSEMBLY WITH A MICRO-MOVER FOR MICROELECTRO-MECHANICAL SYSTEMS,” filed Oct. 26, 2006 and incorporated herein by reference. The movable media platform 103 can rely on a pair of capacitive sensors arranged at four locations (although alternatively more or fewer locations) using each pair of capacitive sensors for extracting a ratio-metric signal independent of Z-displacement of the movable media platform 103. Preferably, two electrodes (not shown) are formed on the cap 144. A third electrode 163 can be integrally formed or fixedly connected with the movable media platform 103 to form a differential pair. Two capacitors are formed, one between the first electrode and third electrode 163 and one between the second electrode and the third electrode 163. A ratio of capacitances can be sensitive to horizontal displacement of the movable media platform 103 with respect to the stationary portion 126 along an axis (X displacement) and this ratio can be insensitive to displacements of the movable media platform 103 with respect to the stationary portion 126 along other axes (Y and Z displacement). For a pair of capacitive sensors adapted to measure motion along an axis, at least two readings can be obtained from which can be extracted displacement along the axis and rotation about a center of the movable media platform 103. Processing signals from all capacitive sensors allows extracting three displacement and three rotational components of the motion of the movable media platform 103 with respect to the cap 144.

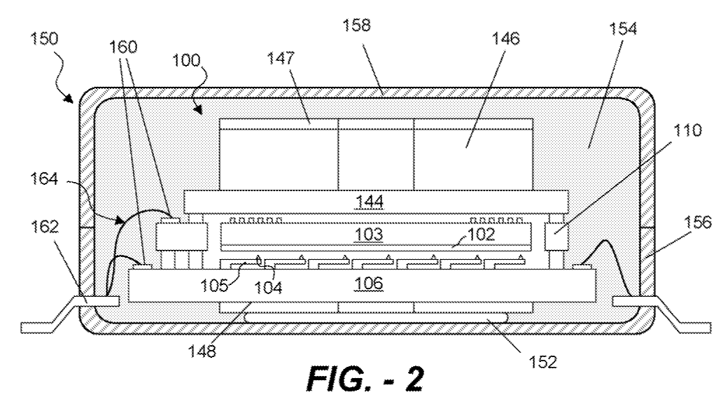

Referring to FIG. 2, a simplified cross-sectional view of the memory device 100 of FIG. 1 is shown arranged within an exemplary package 150 in accordance with typical packaging techniques of the prior art. The cap 144 is shown bonded to the media frame 110, which is bonded to the tip die 106, sealing the movable media platform 103 between the cap 144 and the tip die 106. A permanent magnet 146 and flux plate 147 can be adhesively connected with the cap 144 and a complementary plate 148 can be adhesively connected with the tip die 106. The stack, which includes the structures arranged between the two flux plates 147,148, can be fixedly associated with the package 150, for example by bonding the complementary flux plates 148 (and therefore the stack) to a bowl 156. Lead wires 164 are connected between bond pads 160 associated with the respective die and leads 162 that extend outside of the package 150, allowing the memory device 100 to electrically interface with an interface controller or other external device. The package 150 may then optionally be filled with a fill material 154 added to the cavity between the stack and the package body 150. The fill material 154 covers the interior portion of the leads 162 and partially covers wire bonding in the interior of the package body 150. The fill material 154 can be, for example, an epoxy resin for mechanically supporting the package 150 and protecting the wire bonds and memory device 100.

The package 150 of FIG. 2 can be subjected to external forces during use. The external forces may result from changes in environmental conditions. External forces can increase where the memory device 100 is used in equipment that is exposed to environmental extremes, such as under-pressurized portions of aircrafts or below sea level environments. External forces may also result from shock and vibration forces. Memory devices 100 may also be subjected to external forces of increased magnitude and frequency where the memory device 100 is supplied in a form factor that exposes the packaging to handling, for example where the memory device is included in a memory card format. Memory card formats such as CompactFlash (CF), MultiMediaCard (MMC), Memory Stick, Secure Digital (SD), and xD are commonly used in consumer applications such as digital cameras and video game consoles. Memory cards are handled by the consumer often and can be dropped, squeezed, twisted, and otherwise physically manipulated so that force is applied to the package. In some cases, the memory device will be subjected to extreme environmental conditions and shock and/or vibration.

The memory device 100 can benefit in improved lifetime and performance if the gap between the movable media platform 103 and the tip die 106 is generally consistent and substantially unaffected by environmental conditions and shock and/or vibration. As can be seen in FIG. 2, a cavity exists between the cap 144 and the movable media platform 103 and between the tip die 106 and the movable media platform 103. The cavity is referred to hereinafter as a media cavity. Deformation forces applied to the package 150, which can include twisting and bending, can cause one or both of the cap 144 and the tip die 106 to displace toward the movable media platform 103. The displacement can cause, for example, tips 104 to be urged against the media 102 with unintended force. Such force can result in performance errors and/or abrasion to one or both of the media 102 and one or more tips 104. Abrasion to a tip 104 can reduce a lifetime of the tip 104 with a degree of severity depending at least in part on the geometry of the tip 104 (conical shaped tips will exhibit large variation in cross-sectional diameter as they wear from an initial terminus). Techniques for managing wear of tips can be compromised if tips do not wear according to a generally predictable pattern. For example, deformation force applied to a package such as shown in FIG. 2 can be disproportionately transferred to tips 104 near the center of the tip die 106, where resistance to a moment component of the deformation force is weakest. Further, if a cantilever 105 from which a tip 104 extends is actuated by an electrical signal, deformation force can produce stress in the cantilever 105 which can result in breakage and/or fatigue.

An opposite problem can occur under environmental conditions were external pressure is reduced (and the net internal pressure increases). Under such conditions the media cavity can increase in distance so that a gap between the tip die 106 and media 102 can result in insufficient contact between a tip 104 and the media 102. Where there is insufficient contact force between the tip 104 and the media 102, a breakdown voltage may be insufficient to overcome interference from otherwise low levels of contamination. For example, a hydrocarbon layer formed over the media can necessitate an increase in contact force between a tip and a media. Further, if a gap between the tip 104 and the media 102 is too large, the breakdown voltage may be insufficient to breach the gap to affect the media 102 during writing, for example.

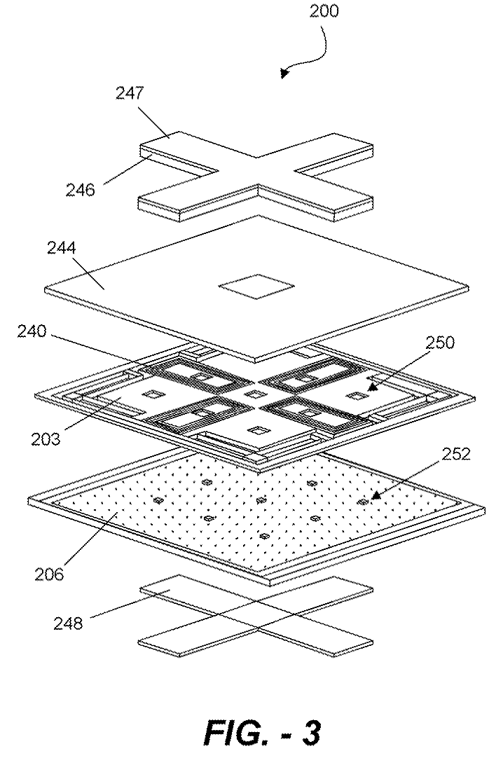

Referring to FIG. 3, an embodiment of a memory device 200 in accordance with the present invention can comprise a tip die 206 having one or more compression members 272 extending from the tip die 206 so that the one or more compression members 272 are in contact with the cap 244, or in sufficient proximity to the cap 244 such that a desired minimum gap is maintained between the tip die 206 and the cap 244 when a range of deformation force is applied. To accommodate the compression members 272, the movable media platform 203 can include windows 274 having planar dimensions corresponding at least to a range of relative movement of the compression member 272 based on a range of movement of the movable media platform 203. It will be noted, therefore, that it can be desired to employ a number of compression members 272 and a footprint of the compression members 272 that maximize useable surface area on the tip accessible surface of the movable media platform 203 while providing a desired resistance to deformation forces that urge one or both of the tip die 206 and the cap 244 toward each other (i.e., that collapse the media cavity). The memory device 200 can include one or more compression members 272 extending from the tip die 206 toward the cap 244. However, in an alternative embodiment, the memory device 200 can include can include one or more compression members 272 extending from cap 244 toward the tip die 206. In still further embodiments, the compression members 272 can be fixedly connected between the cap 244 and the tip die 206 so that the compression members 272 resist tension forces as well as compression forces.

As shown in FIG. 3, an embodiment is proposed having a layout including nine compression members 272 arranged over a footprint of the tip platform 206 and extending from the tip platform 206 and through corresponding windows 274 to contact the cap 244. The compression members 272 can be evenly distributed over the footprint of the tip die 206, or alternatively arranged to distribute deformation forces as desired between the tip platform 206 and the cap 244. Further, the compression members 272 need not have a uniform size (i.e., cross-sectional area). For example, it may be observed that deformation force concentrates near a center of the memory device. A compression member 272 having a larger cross-section than other compression members 272 can be provided extending between the tip die 206 and cap 244 near the center of the memory device. Alternatively, it may be desirable to provide additional support where “real estate” of the media 202 is reserved for critical data. The additional support can include strategic positioning of the compression member(s) 272 and/or increased compression member 272 cross-sectional areas near or around the critical areas.

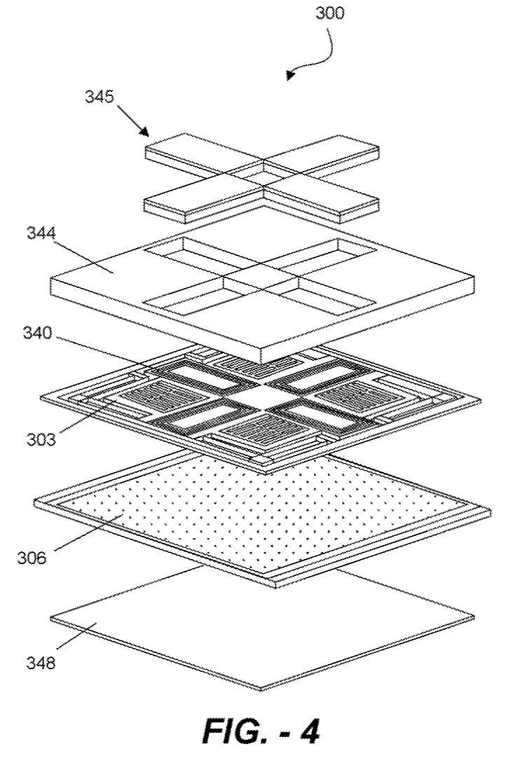

Referring to FIG. 4, an alternative embodiment of a memory device 300 in accordance with the present invention can comprise a cap 344 having an increased thickness and an insert-molded magnet structure 344. A memory device-in-package conforming to a memory card format must be within dimensional tolerances for the memory card format. For example, SD compact flash format designates a 2.1 mm thickness, while MMC format designates a 1.4 mm thickness. Insert molding at least a portion of the magnet structure 345 within the cap 344 can provide a combination of strength and form factor. A cap 344 having increased thickness over caps such as shown in FIG. 1 can provide increased strength for resisting transferal of deformation forces to a movable media platform 303 and/or tip die 306 while meeting a thickness requirement of a memory card format. Insert molding at least a portion of the magnet structure 345 within the cap 344 may also increase the precision with which the magnet structure 340 is aligned relative to the coils 340 of the electromagnet motor formed on the movable media platform 303. However, the magnet structure 345 need not be insert-molded. Alternatively, cut-outs can be machined or otherwise formed in the cap 344 for receipt of at least a portion of the magnet structure 345. Further, the second flux plate 348 for containing the magnetic flux can be sized to correspond roughly to a footprint of the tip die 306 to provide additional structural strength without thickening the memory device 300. Alternatively, the second flux plate 348 can be integrally formed with a bowl of the package to reduce a number of components of the memory device-in-package and thereby reducing the overall thickness of the memory device-in-package and/or strengthening the memory device-in-package to resist deformation forces. In still further embodiments, both compression members and a cap having increased thickness can be included in a memory device.

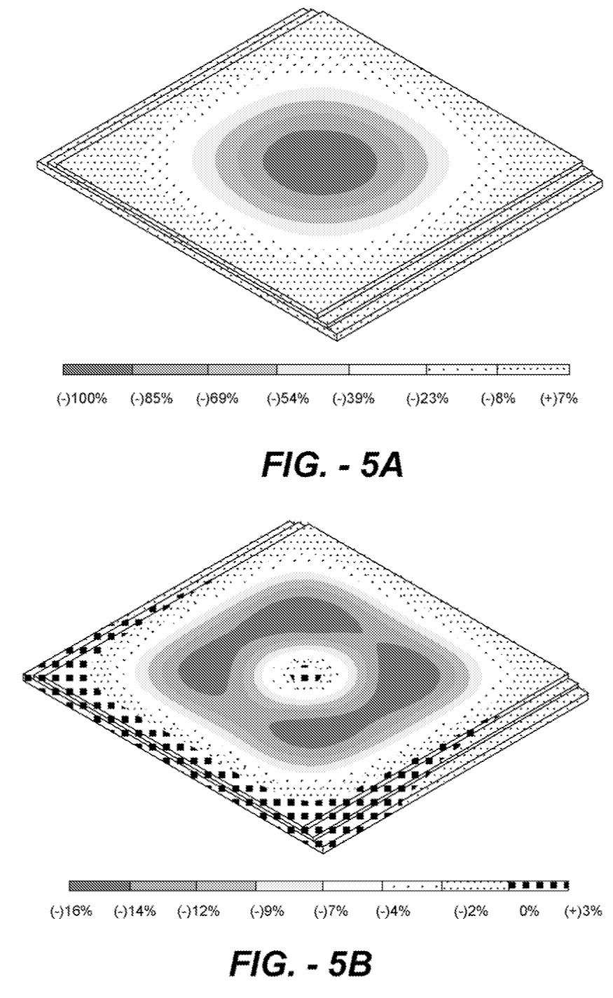

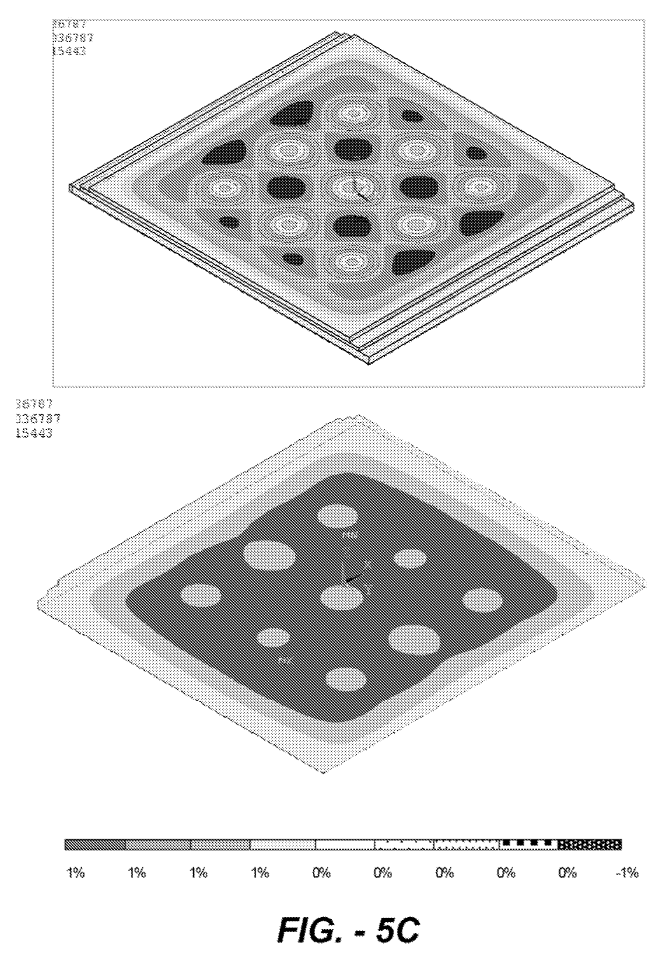

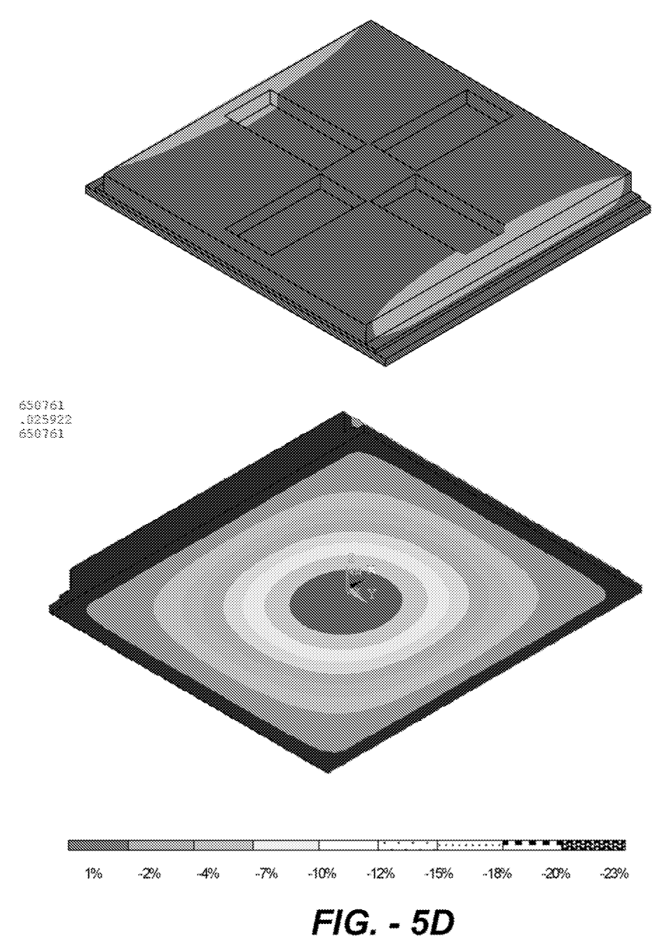

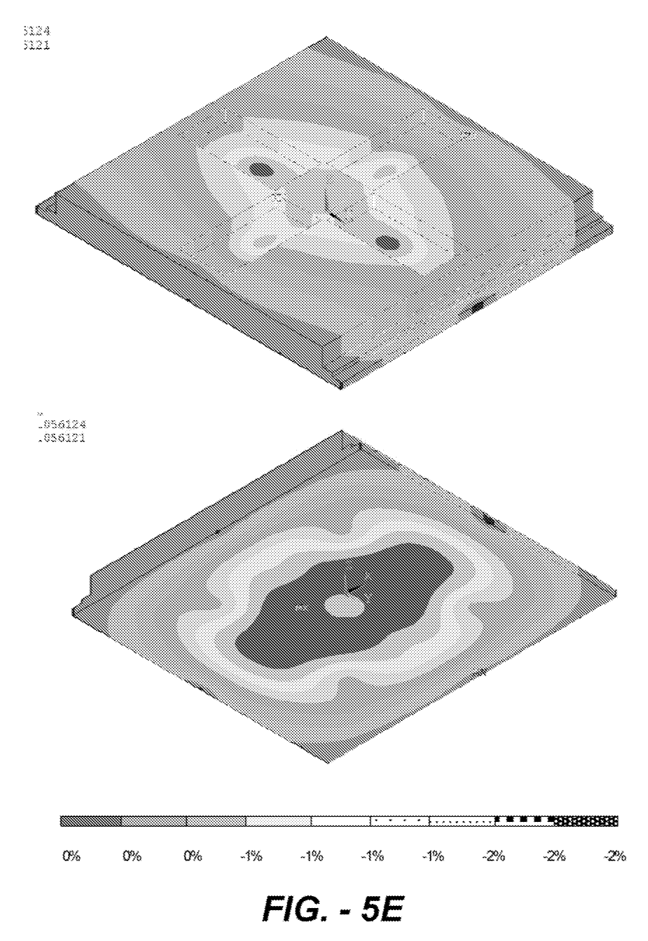

Referring to FIGS. 5A-5E, five embodiments of memory device in accordance with the present invention were analyzed using finite element modeling. Contour maps are provided showing distortion (i.e., displacement of the media cavity) resulting from external forces on the memory device (in this case the external force is a simulation of air pressure effects). FIG. 5A illustrates distortion of an embodiment of a memory device as shown in FIG. 1. The memory device stack includes a 150 μm thick cap and a 250 μm thick tip die, with a 136 μm thick movable media platform arranged between the cap and tip die so that a 10 μm gap exists between tip die and movable media platform. The memory device was simulated operating at low altitude conditions of −1,500 ft and 0.8 psi net external pressure (15.5 psi external pressure acting against 14.7 psi internal pressure). The results are provided as normalized percentages of a maximum distortion. As shown, maximum distortion occurs in the center of the memory device, with the media cavity collapsing to urge the tip die and/or cap toward the movable media platform. Note that normalized percentages including a “(+)” symbol represent an increase in media cavity height relative to nominal, while normalized percentages preceded by “(−)” represent a decrease in media cavity height relative to nominal. The maximum distortion at low altitude (high external pressure) results in nearly 3 μm of decreased distance between the tip die and the moveable media platform. The maximum distortion at high altitude (high internal pressure) results in over 26 μm of increased distance between the tip die and the moveable media platform.

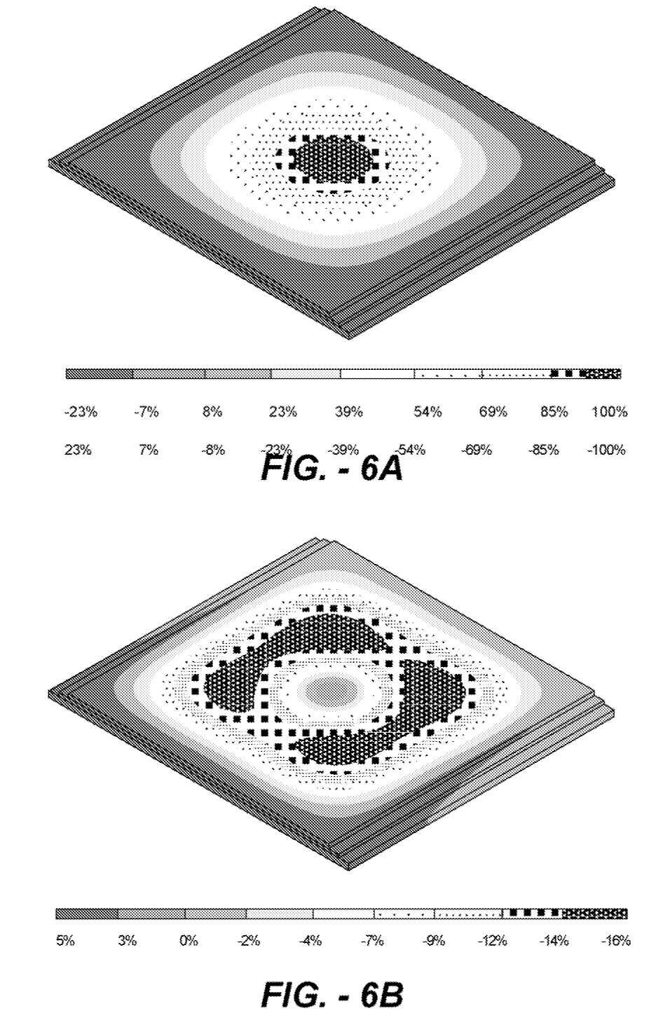

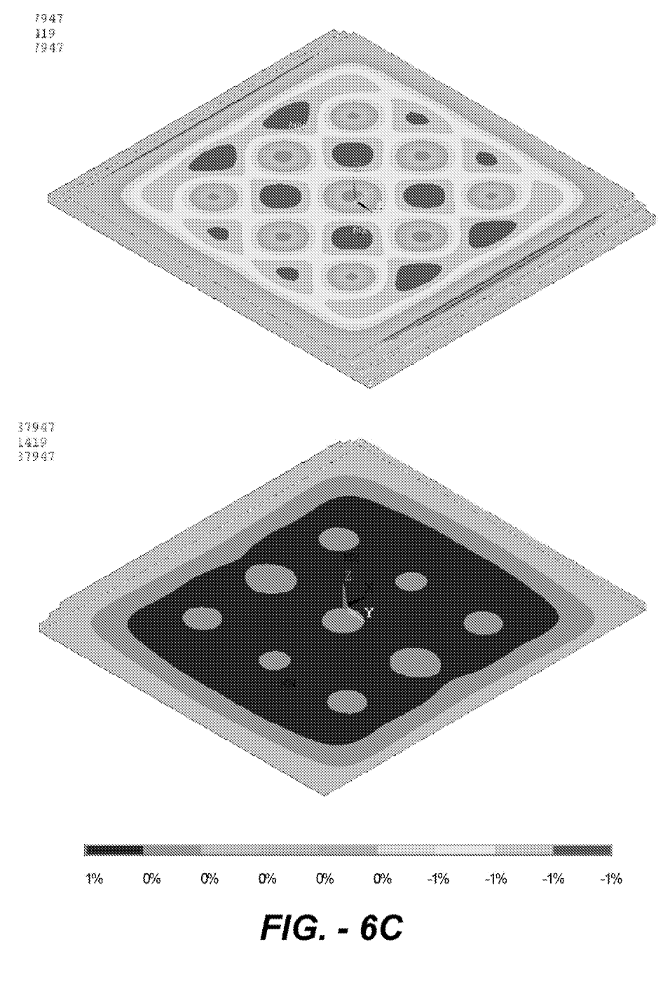

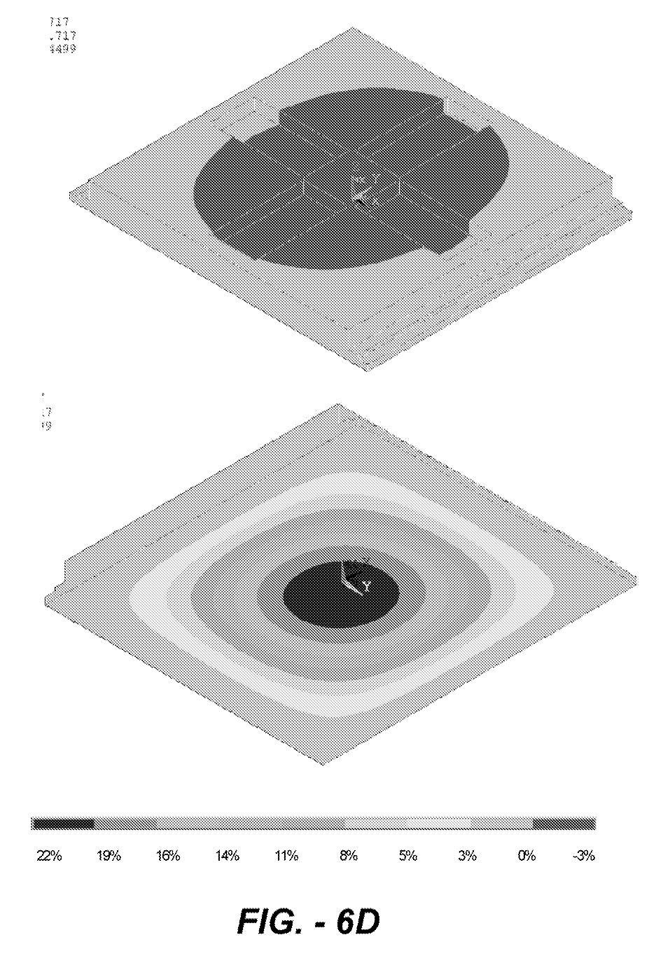

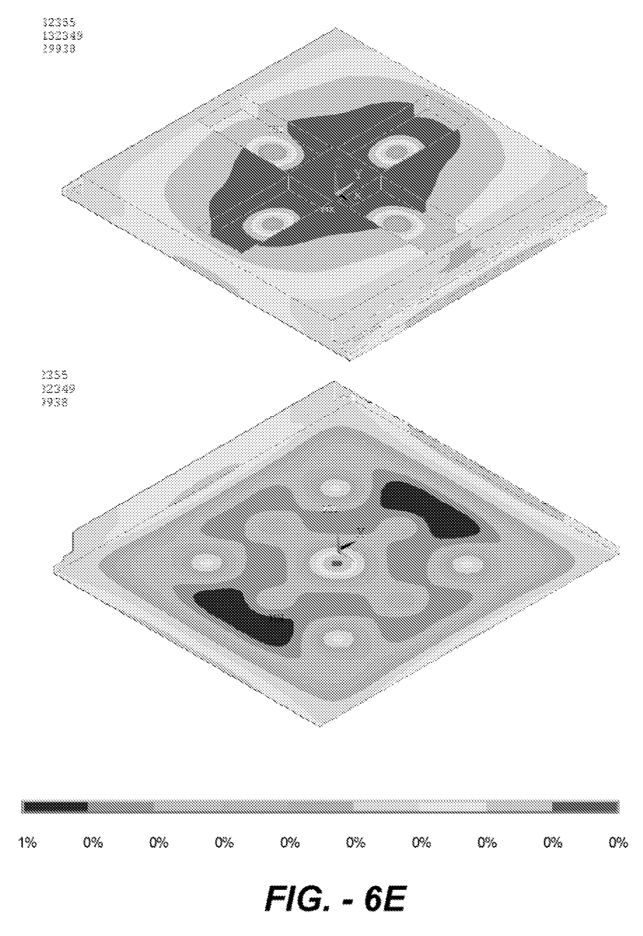

FIGS. 5B and 6B illustrate distortion of an embodiment of a memory device including a single compression member extending from a position centrally located along the tip die. The memory device stack was modeled having the same dimensions as above. The compression member was modeled having planar dimensions of 200 μm×200 μm. The memory device was simulated operating under the low altitude conditions, with the results shown in FIG. 5B. As can be seen, the maximum distortion is reduced by more than a factor of five when compared with the maximum distortion of the embodiment of FIG. 5A. The memory device was also simulated operating under the high altitude conditions, with the results shown in FIG. 6B. The maximum distortion is reduced by more than a factor of five at high altitude as well. The maximum distortion occurs during the high altitude simulation, and results in 4.3 μm of increased distance between the tip die and the moveable media platform

FIGS. 5C and 6C illustrate distortion of an embodiment of a memory device as shown in FIG. 3 including nine compression members extending from the tip die and arranged roughly evenly along the footprint of the movable media platform. The memory device stack was modeled having the same dimensions as above. The memory device was simulated operating under the low altitude conditions. As can be seen, the maximum distortion is just over 1% of the maximum displacement of the embodiment of FIG. 5A. The memory device was also simulated operating under the high altitude conditions, with the results shown in FIG. 6B. Again, the maximum distortion is just over 1% of the maximum displacement of the embodiment of FIG. 5A. The maximum distortion occurs during the high altitude simulation, and results in 338 nanometers of increased distance between the tip die and the moveable media platform.

FIGS. 5D and 6D illustrate distortion of an embodiment of a memory device as shown in FIG. 4 including a tall cap within which a magnet structure is at least partially arrangeable. The tip die and movable media platform were modeled having the same dimensions as above (250 μm thick tip die, with a 136 μm thick movable media platform arranged between the cap and tip die so that a 10 μm gap exists between tip die and movable media platform). However, the cap thickness was increased to 700 μm (175 μm deep within cut-outs). The memory device was simulated operating under the low altitude conditions, with the result shown in FIG. 5D. The maximum distortion is reduced by more than a factor of four when compared with the maximum distortion of the embodiment of FIG. 5A. The memory device was also simulated operating under the high altitude conditions, with the results shown in FIG. 6D. The maximum distortion is reduced by more than a factor of four at high altitude as well. The maximum distortion occurs during the high altitude simulation, and results in nearly 6 μm of increased distance between the tip die and the moveable media platform.

FIGS. 5E and 6E illustrate distortion of an embodiment of a memory device including nine compression members extending from the tip die and arranged roughly evenly along the footprint of the movable media platform (for example as shown in FIG. 3) and a tall cap within which a magnet structure is at least partially arrangeable (for example as shown in FIG. 4). The memory device stack was modeled having the same dimensions as the memory device of FIGS. 5D and 6D. The memory device was simulated operating under the low altitude conditions. As can be seen, the maximum distortion is about 0.5% of the maximum displacement of the embodiment of FIG. 5A. The memory device was also simulated operating under the high altitude conditions, with the results shown in FIG. 6B. Again, the maximum distortion is about 0.5% of the maximum displacement of the embodiment of FIG. 5A. The maximum distortion occurs during the high altitude simulation, and results in 132 nanometers of increased distance between the tip die and the moveable media platform.

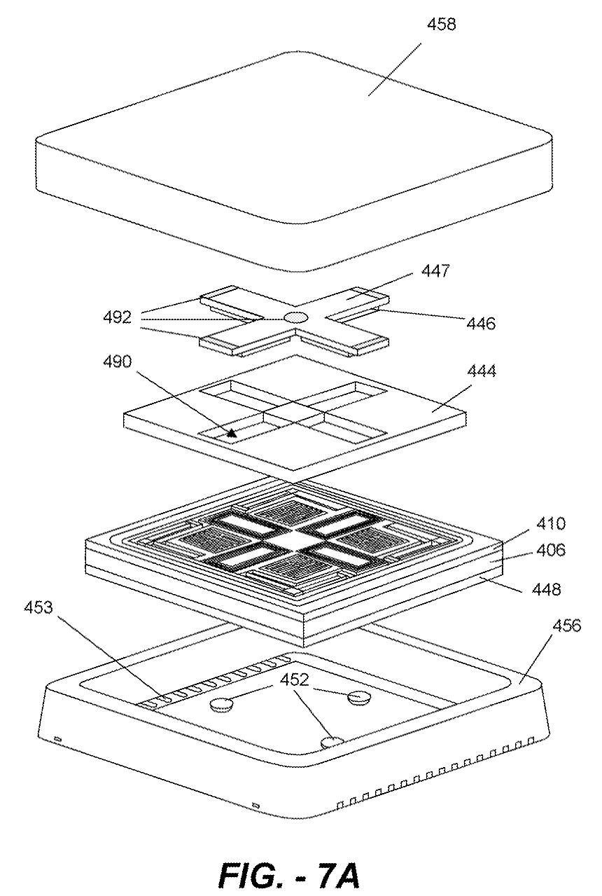

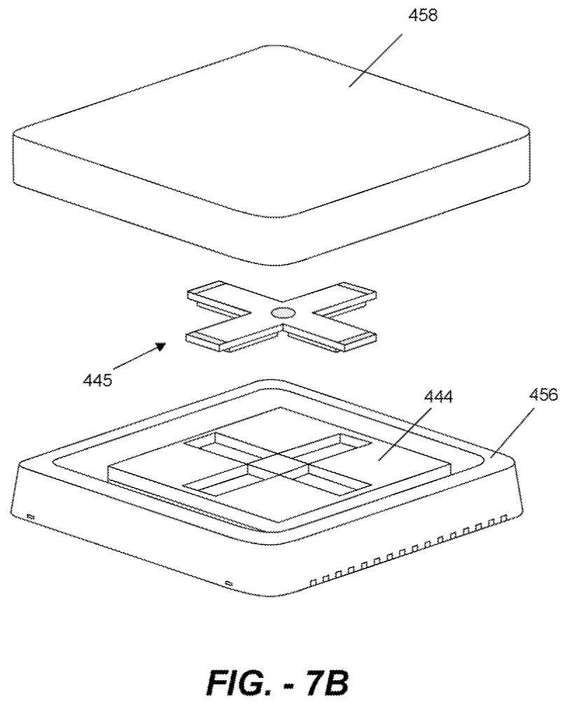

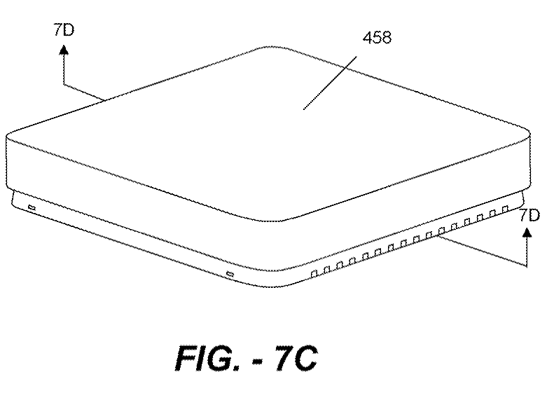

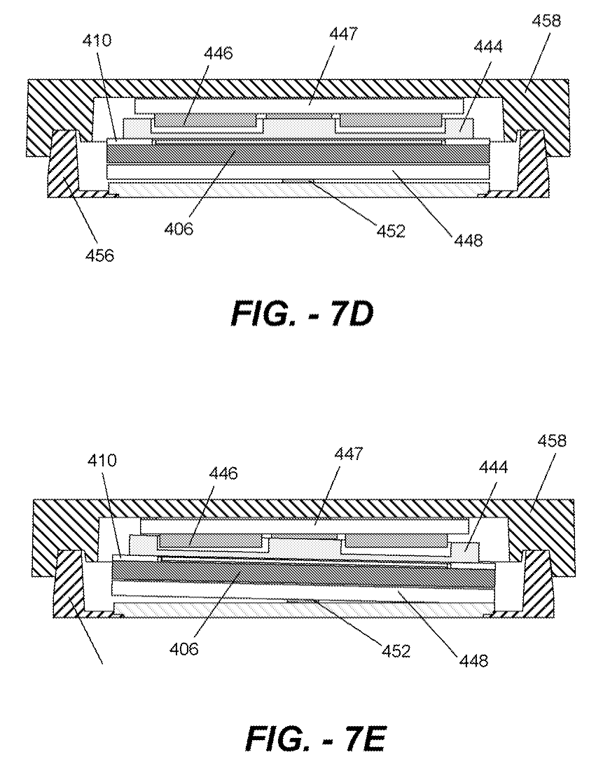

Referring to FIGS. 7A-7E, an embodiment of a memory device and package in accordance with the present invention is shown. FIGS. 7A and 7B are exploded perspective views showing components of the memory device 400 and the package 450. As can be seen, the memory device 400 includes a cap 444 with cut-outs 490 for receiving one or both of magnets 446 and a first flux plate 447, which are bonded together to form magnet structure 445. The magnet structure 445 as shown is bonded to a lid 458 of the package 450 at five bonding points 492. The magnet structure 445 can be bonded to the lid 458 using any known technique in the semiconductor packaging field. A media stack includes the cap 444 bonded to one surface of a media frame 410 and a tip die 406 bonded to the other surface of the media frame 410 so that a movable media platform 403 is arranged between the cap 444 and the tip die 406. A second flux plate 448 is bonded to the tip die 406.

As can be seen particularly in FIG. 7A, embodiments of packages in accordance with the present invention can include floating supports 452. Three floating supports 452 positioned to achieve a target balance of the media stack when the media stack is seated in the package can provide planar stability while allowing the media stack to “tip” in three directions in response to a shock event, vibration, twisting, etc. Such an arrangement can reduce impact of severe shock events and other distortion forces on the tip die 406 and movable media platform 403 by yielding to the distortion force and tipping, rather than absorbing the distortion force. Referring to FIGS. 7D and 7E, cross-sectional diagrams of the memory device seated within the package show the result of a severe shock impact. In FIG. 7D the memory device is shown with the media stack bonded together, but with the magnet structure 445 loosely received within the cut-outs 490 of the cap 444. In FIG. 7E it can be seen that this configuration allows the magnet structure 445 to adjust within the cut-outs 490 and accommodate shifting movement of the media stack as it tilts over a pair of floating supports 452 in response to a shock event. As shown the supports are cylindrical bosses formed in the bowl 456. However, as will be appreciated by one of ordinary skill in the art upon reflection on the present teachings, in other embodiments, the supports can be formed on the second flux plate 448, and/or alternatively can have some other shape, such as semi-spherical, triangular, or pyramidal.

Referring again to FIG. 7A, in order to enable communication between the memory device and a host, controller, or other external device, the tip die 406 and media die 424 should be wire bonded to leads 453 of the package. In an embodiment, the media stack can be fixedly connected with the bowl 456 and/or the supports 452 with a sacrificial adhesion layer (e.g., photoresist is dissolvable using solvents)(not shown). The leads 453 can then be wire bonded to bond pads of the tip die 406 and media frame 410. Once wire bonding is complete, the sacrificial adhesion layer can be dissolved so that the memory device 400 can “float” within the package. As shown in FIG. 7C, the package lid 458 can then be fixedly connected with the bowl 456 so that the magnet structure 445 seats as desired within the cut-outs of the lid 458 with the designed tolerance for media stack movement.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A memory device for storing information comprising:
a cap;
a tip die;
a movable media platform arranged between the cap and the tip die;
a media fixedly associated with the movable media platform and accessible to the tip die;
a compression member extending between the tip die and the cap;
wherein the movable media platform includes a window through which the compression member extends.

2. The memory device of claim 1, wherein the window has planar dimensions corresponding to an unimpeded range of motion of the compression member.

3. The memory device of claim 1, further comprising:
a plurality of cantilevers connected with the tip die; and
a plurality of tips extending from corresponding cantilevers and electrically connectable with the media.

4. The memory device of claim 1, wherein the media is one of a ferroelectric material, a phase-change material, and a polarity dependent material.

5. The memory device of claim 1, further comprising:
an electromagnetic motor including an electrical trace and a magnet; and
wherein the cap includes cut-outs for receiving at least a portion of the magnet.

6. The memory device of claim 1, further comprising:
an electromagnetic motor including an electrical trace and a magnet; and
wherein the magnet is insert molded into the cap.

7. A memory device for storing information comprising:
a cap including a magnet at least partially arranged in the cap;
a tip die;
a movable media platform arranged between the cap and the tip die;
a media fixedly associated with the movable media platform and accessible to the tip die;
an electromagnetic motor to urge the movable media platform including an electrical trace and the magnet.

8. The memory device of claim 7, further comprising:
a plurality of cantilevers connected with the tip die; and
a plurality of tips extending from corresponding cantilevers and electrically connectable with the media.

9. The memory device of claim 7, further comprising:
a compression member extending between the tip die and the cap;
wherein the movable media platform includes a window through which the compression member extends.

10. The memory device of claim 9, wherein the window has planar dimensions corresponding to an unimpeded range of motion of the compression member.

11. The memory device of claim 7, wherein the media is one of a ferroelectric material, a phase-change material, and a polarity dependent material.

12. A system for storing information comprising:
a package including a lid, a bowl mateable with the lid, and leads extending from an interior of the package to an exterior of the package;
a magnet structure including a first flux plate and a magnet, wherein the first flux plate is fixedly connected with the lid;
a media stack including:
a cap including cut-outs for receiving at least a portion of the magnet structure,
a media frame connected to the cap,
a tip die connected to the media frame,
a second flux plate connected with the tip die,
a movable media platform movably connected with the frame and arranged between the cap and the tip die,
an electric trace formed on the media platform so that the electric trace is arranged between the media platform and the cap, and
a media fixedly associated with the movable media platform and accessible to the tip die;
wherein the media stack is seated within the bowl; and
wherein the media stack is wire-bonded to the leads.

13. The system of claim 12, further comprising a plurality of support structures arranged on one or both of the second flux plate and the bowl; and
wherein the media stack is adapted to tilt within the package.

14. The system of claim 13, wherein the plurality of support structures includes three support structures arranged in a triangular relationship so that the media stack is tiltable along one of three axes defined by two of the three support structures.

15. The memory device of claim 12, further comprising:
a plurality of cantilevers connected with the tip die; and
a plurality of tips extending from corresponding cantilevers and electrically connectable with the media.

16. The memory device of claim 12, further comprising:
a compression member extending between the tip die and the cap;
wherein the movable media platform includes a window through which the compression member extends.

17. The memory device of claim 16 wherein the window has planar dimensions corresponding to an unimpeded range of motion of the compression member.

18. The memory device of claim 12, further comprising:
a plurality of cantilevers connected with the tip die; and
a plurality of tips extending from corresponding cantilevers and electrically connectable with the media.

19. The memory device of claim 12, wherein the media is one of a ferroelectric material, a phase-change material, and a polarity dependent material.
